(19) United States
(12) Patent Application Publication
(10) Pub. No.: US 2008/0173409 A1
(43) Pub. Date: Jul. 24, 2008

(54) Roman Shade

(75) Inventors: Richard Wayne Robertson, Westminister, CO (US); Richard Wayne Robertson, Apache Junction, AZ (US); Ramon Trujillo, Denver, CO (US)

Correspondence Address: SHERIDAN ROSS PC, 1560 BROADWAY, SUITE 1200, DENVER, CO, 80202, US

(73) Assignee: D.S.C. FABRICS, INC., Arvada, CO (US)

(21) Appl. No.: 11/625,775

(22) Filed: Jan. 22, 2007

(51) Int. Cl. E06B 9/24

(52) U.S. Cl. 160/84.01

(57) ABSTRACT

A Roman shade is constructed of two continuous sheets of material forming the front and rear faces thereof. Pleat assemblies create panels in the shade, and oppositely disposed panels form insulating cells that help the shade to create an air barrier for insulating the window covered by the shade. Horizontal folds made in the front and rear faces form the pleat assemblies. Retaining strips are provided along with eyelets to assemble the pleat assembly. An optional sheer assembly may be hung below the shade wherein lower overhangs of the shade hide the sheer assembly when the sheer assembly is raised.

### FIELD OF THE INVENTION

This invention relates to window coverings such as Roman shades, and more particularly, to a Roman shade having front and rear faces each made from separate and continuous sheets of material wherein a plurality of pleats formed along the length of the shade create insulating air gaps between the sheets of material.

### BACKGROUND OF THE INVENTION

Roman shades are window coverings characterized by horizontally oriented segments or panels spaced from one another along the length of the shade. The shade may be progressively raised and lowered and when raised, the segments or panels overlap one another. The panels created in traditional Roman shades utilize metal or wooden slats to maintain the linear horizontal orientation of the panels such that when the shade is raised, the folds created in the material present a uniform, stacked arrangement.

It is also typical to control the opening and closing of a Roman shade by pull strings guided by string guides. However, many types of Roman shades are particularly complex in their method of manufacture and are somewhat awkward to handle, as well as to assemble. The method of manufacturing some Roman shades has evolved over time, to include manufacturing techniques to sew the material to make the string guides, drawstrings, and plates more efficient. However, many Roman shade constructions still require use of battens and stitched pockets for receiving the battens, and use of such battens requires the use of a plastic sheet material in its method of construction. Additionally, prior art Roman shade constructions are particularly unattractive when viewed from outside the room in which the Roman shade is installed. The exterior or rear side of the shade may have exposed hardware or other components because such Roman shade constructions do not incorporate aesthetically pleasing rear panels or surfaces. Thus, there is a need to provide a functional yet aesthetically pleasing Roman shade construction that hides or covers unattractive exposed hardware.

There is also a need to provide a window covering that provides some additional insulation benefit to the window being covered. Although windows are desirable in most building and homes, additional costs are associated with heating and cooling such structures because the windows are not as well insulated as the walls of the structure. Thus, it is desirable to provide a window covering wherein the window covering can provide some insulative benefit.

To address some of the shortcomings of the prior art, one object of the present invention is to provide a Roman shade construction that may yield substantial savings in material and labor costs by providing a simple yet functional and aesthetic design.

It is yet another object of the present invention to provide a Roman shade construction wherein some insulative benefit may be provided to the room in which the shade is installed by creation of an air barrier within the shade to thereby assist in insulating the window opening.

It is yet another object of the present invention to provide a Roman shade construction wherein the side of the shade that faces the exterior of the room in which the shade is installed has an additional layer or panel of material to hide or cover unattractive exposed hardware.

### SUMMARY OF THE INVENTION

In accordance with the present invention, a Roman shade is provided that utilizes simple yet effective pleat assemblies wherein air pockets or gaps are created between rear and front faces of the shade to provide an insulating air barrier. More particularly, a Roman shade constructed in accordance with the present invention is provided with a front face or body made of a continuous sheet of flexible material, and a rear face or body made of another continuous sheet of flexible material. The sheets of material are each segmented into a plurality of rear and front panels by the pleat assemblies. The pleat assemblies include folds made in the sheets of material that separate the shade into respective cells. Each cell defines a separate air pocket or gap. The pleat assemblies extend horizontally and are spaced vertically from one another. Stiffening reinforcement is provided to the pleat assemblies by use of one or more retaining strips. Eyelets are used to secure the retaining strips to the folded material and the eyelets are also used as string guides to route pull strings used to raise and lower the shade. Optionally, a shear assembly may also be used with the shade. The shear is secured to a lower end of the shade and can be independently operated to raise or lower the shear. The shear is preferably made from a thinner type of material that allows some light to pass through, yet provides privacy to the user since the shear still covers the window opening.

Other features and advantages of the present invention will become apparent from a review of the following detailed description, taken in conjunction with the drawings.

### BRIEF DESCRIPTION OF THE DRAWINGS

FIG. 1 is a front perspective view of the Roman shade of the present invention wherein the Roman shade is lowered and the sheer assembly is raised;

FIG. 2 is another front perspective view of the Roman shade of the present invention wherein the shade is raised and the sheer assembly is lowered;

FIG. 3 is another front perspective view of the Roman shade of the present invention wherein the Roman shade is partially raised and the sheer assembly is partially lowered;

FIG. 4 is a front elevation view of the Roman shade as shown in FIG. 3;

FIG. 5 is an enlarged partial fragmentary perspective view of an upper part of the Roman shade showing rear details of the construction of the shade;

FIG. 6 is an enlarged partial fragmentary perspective view of a lower part of the Roman shade illustrating the sheer assembly raised, and wherein lower panels of the shade cover the sheer assembly;

FIG. 7 is a side elevation view of the Roman shade when the Roman shade is in the position of FIG. 1;

FIG. 8 is a greatly enlarged fragmentary perspective view of the Roman shade further illustrating details of construction;

FIG. 9 is a greatly enlarged fragmentary perspective view of the Roman shade illustrating the construction of the Roman shade at the lower end thereof;

FIG. 10 is a vertical cross-sectional view of the shade further illustrating construction details thereof;

FIG. 11 is a front perspective view of a second embodiment of the present invention wherein the front side or face incorporates additional material in each panel;

FIG. 12 is a greatly enlarged fragmentary vertical section illustrating construction details of the embodiment of FIG. 11.

### DETAILED DESCRIPTION

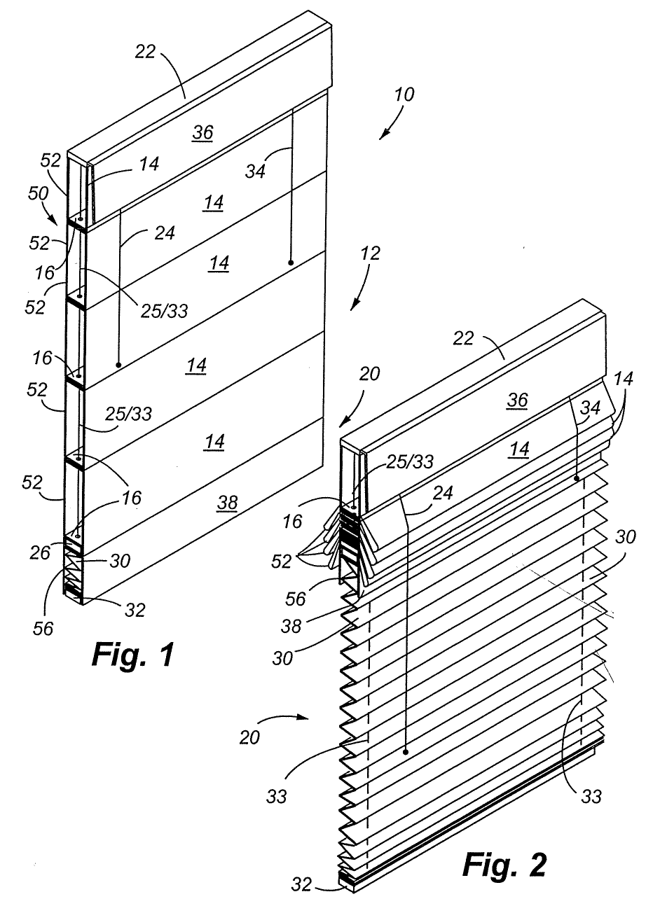

FIGS. 1-10 illustrate a first preferred embodiment of the present invention. Referring first to FIGS. 1-3, the Roman shade 10 comprises a front face or body 12 and a rear face or body 50. The front and rear faces are separated into respective front panels 14 and rear panels 52. An insulating cell is a rectangular shaped open space or gap created between respective facing panels of the front and rear faces when the shade is lowered. More specifically, the front and rear panels each have exposed exterior surfaces and non-exposed interior surfaces. The facing interior surfaces of oppositely disposed front and rear panels form vertical boundaries defining the cells. The horizontal boundaries of the cells are formed by the respective pleat assemblies 16. A pleat assembly 16 is located at each horizontal line of connection between the rear and front panels.

The optional sheer assembly 20 is hung below a bottom rail 26 connected to lower ends of the faces 12 and 50. Reference made to just the term “shade” hereinafter refers specifically to the front face, rear face, and pleat assemblies and not to the sheer assembly. The rail 26 provides some additional weight to ensure that the shade hangs vertically and the panels 14 and 52 maintain their horizontal and parallel orientation. Drawstring group 24 controls the raising and lowering of the shade. Drawstring group 34 controls the raising and lowering of the sheer assembly 20. Conventional pulley systems (not shown) incorporated within the header 22 enable the drawstring groups 24 and 34 to raise and lower the shade and sheer assembly. More specifically, a pair of drawstrings is incorporated on opposite lateral sides of the shade and the drawstrings are routed through a first pulley mechanism (not shown) mounted in the header 22. The exposed drawstring group 24 is therefore the two drawstrings bound together after being routed through the first pulley mechanism. Operating the drawstring group 24 allows the shade to be evenly raised and lowered such that the horizontal orientation of the pleat assemblies and panels is maintained. In the same manner, another pair of drawstrings is used with the shear assembly and the exposed drawstring group 34 may therefore comprise two drawstrings bound together. The sheer assembly as discussed further below also has the pair of drawstrings incorporated on each lateral side of the shear assembly, and a second pulley mechanism (not shown) mounted in the header is used with this pair of drawstrings. The shade and the sheer assembly may be operated independently assuming separate pulley mechanisms are used for each.

In FIG. 2 the shade is shown as raised and the sheer assembly is lowered. When lowered, an accordion folded panel 30 of the sheer assembly is exposed.

In this view, the pair of drawstrings 33 can be seen each extending on opposite lateral sides of the panel 30. The drawstrings 33 are bound together to form the drawstring group 34 after the drawstrings have been routed through the second pulley mechanism. A bottom rail 32 is also incorporated with the sheer assembly in order to provide weight so that the sheer assembly extends directly below the Roman shade.

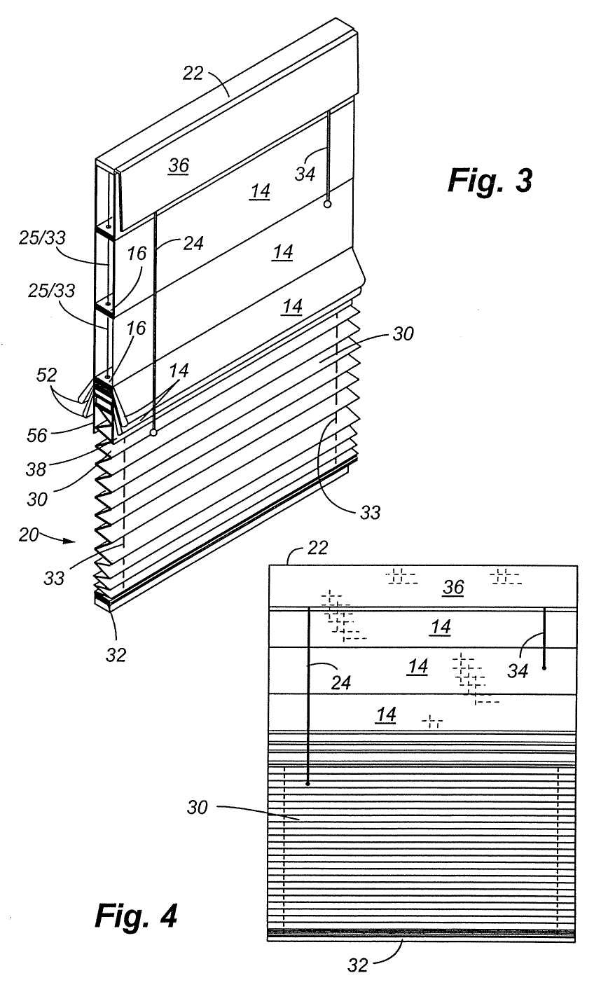

As shown in FIGS. 3 and 4, the shade is partially raised, and the sheer assembly is partially lowered.

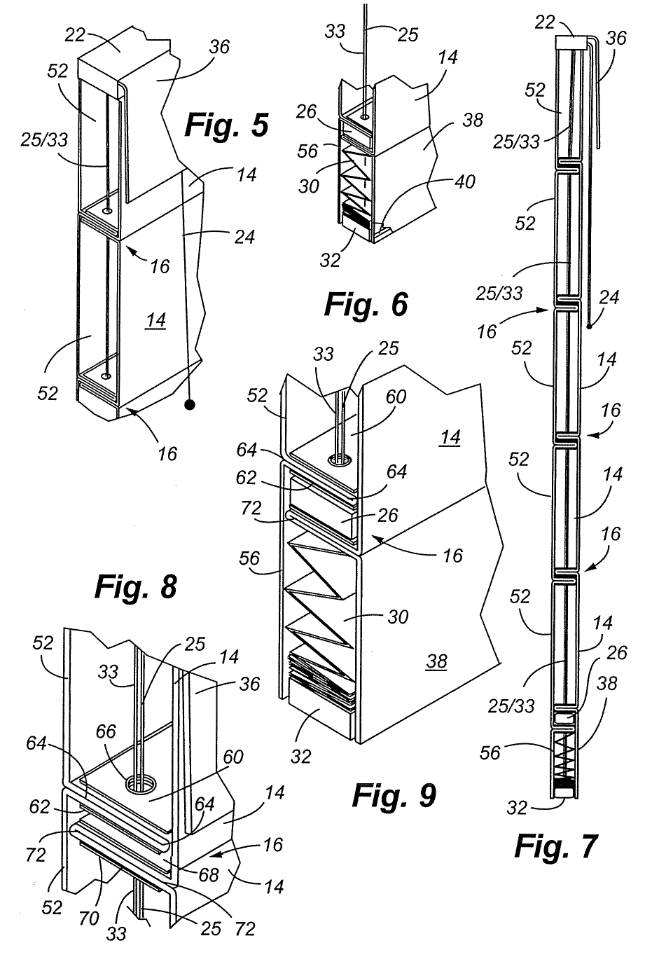

Referring to FIG. 5, further construction details of the present invention are illustrated. An upper front overhang or valence 36 is a separate piece of material that protrudes from the head rail 22, thus covering the head rail and part of the most upper front panel 14.

Referring to FIG. 6, the lower portion of the shade is illustrated. A lower front overhang 38 and a lower rear overhang 56 are provided to hide the sheer assembly 20 when the sheer assembly is raised. As shown in the cutaway portion of the front overhang 38, a rod 40 may be sewn in the material to provide weight so that the overhang 38 extends vertically downward to hide the sheer assembly 20. A rod or weight may also be incorporated in the rear overhang 56 in the same manner. As also shown, the bottom rail 26 is disposed directly above the fold made in the front panel at the location of the lowermost pleat assembly. Drawstring 25 is used to control the raising and lowering of the shade, and another drawstring (not shown) is incorporated on the opposite lateral side of the shade such that drawstring group 24 comprises the two drawstrings.

FIG. 7 illustrates the Roman shade wherein the sheer assembly is fully raised and the shade has been lowered.

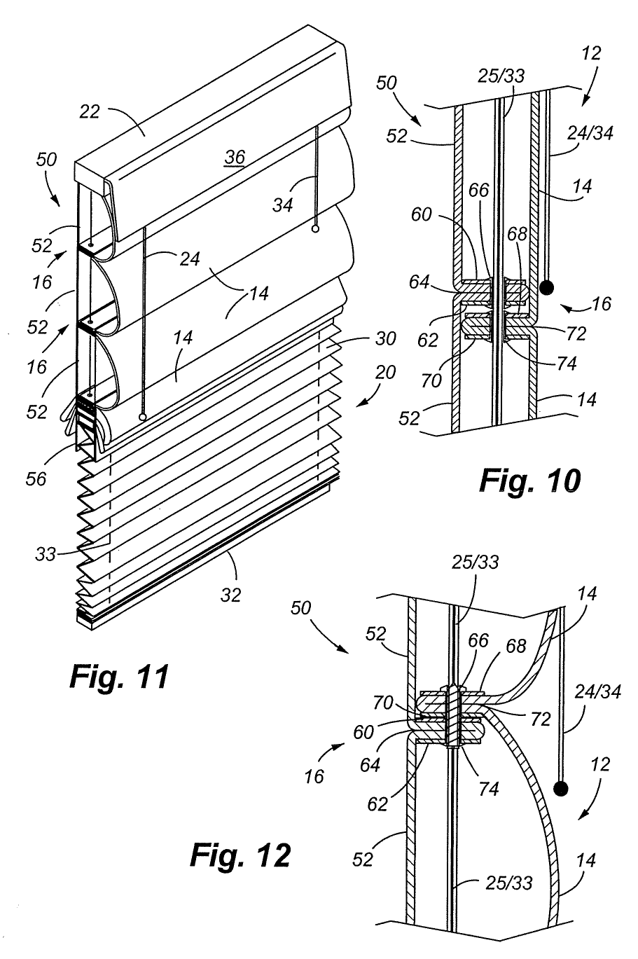

Referring to FIGS. 8-10, the construction of a pleat assemblies 16 are illustrated. As shown, a pleat assembly 16 includes respective folds made on the rear and front panels. More specifically, the front panel 14 includes a fold 72, and the rear panel 52 includes a fold 64. The folds extend horizontally and are therefore oriented perpendicular with respect to the front and rear faces when the shade is lowered. An upper retaining strip 60 and a lower retainer strip 62 secure the rear fold 64 in a horizontal orientation, while the front panel 14 at the fold 72 is retained by an upper retaining strip 68 and a lower retaining strip 70. As shown best in FIG. 10, an upper eyelet 66 and a lower eyelet 74 are used to secure the retaining strips and folds. The eyelets 66 and 74 are also used to route the drawstrings 25 and 33. As necessary, in addition to use of the eyelets 66 and 74, other means may be provided for maintaining the folds 64 and 72, such as adhesive applied to the material or the retaining strips. The opposite lateral side of the shade also utilizes other eyelets 66 and 74 provided in the same arrangement as shown in FIG. 10 thereby creating guides to route the other drawstrings 25 and 33. With the construction illustrated in FIGS. 8-10, effective insulating cells are provided by two continuous pieces of material forming the front and rear faces of the shade.

Referring to FIG. 11, a second embodiment of the invention is illustrated. The same reference numbers in FIG. 11 correspond to the same structural elements as set forth in the first embodiment. The embodiment in FIG. 11 is similar to the first embodiment, except that the front face has front panels that do not extend parallel with the rear face, but rather bulge outwardly thereby providing a different appearance when the shade is viewed from the front.

FIG. 12 illustrates the specific construction of the second embodiment, it being apparent that this construction is the same as the first embodiment with the exception of the specific arrangement of the pleat assembly 16. As shown, the pleat assembly is arranged such that the fold 72 of the front panel 14 is placed on top of the fold 64 of the rear panel 52. However in both embodiments, it shall be understood that either of the folds may be placed on top or bottom in each respective pleat assembly. Also, it shall be understood that while respective upper and lower retaining strips are used for each fold, fewer retaining strips can be used depending upon the type of material used for the front and rear faces. Use of lighter material for the faces may enable use of fewer retaining strips while a more heavy cloth material may require use of more retaining strips.

The advantages of the present invention include the creation of insulating cells formed by just two facing sheets of material. The pleat assemblies may be formed by gathering folds of the rear and front faces and using retaining strips to maintain the folds in a horizontal configuration. Eyelets are used to secure the pleat assembly and to provide guides for the drawstrings. The construction of the shade is simplified because of the continuous sheets of material that are used for the front and rear faces. The pleats are also simplified in that retaining strips and eyelets are the only additional hardware required to form the main body of the shade. The rear face of the shade is not only functional in creating the insulating cells, but also provides are more aesthetic appearance when viewed from outside the room in which the shade is installed. Control of both the shade and the sheer assembly can be achieved by conventional drawstring and pulley combinations.

While the present invention has been set forth in various preferred embodiments, it shall be understood that various other changes and modifications may be made to the invention that fall within the spirit and scope of the invention, in accordance with the scope of the claims appended hereto.

What is claimed is:

1. A Roman shade comprising:
a flexible front face having a plurality of front panels formed thereon, each of said panels having an exposed exterior surface and an interior surface, and said front face extending vertically when the shade is lowered;
a flexible rear face comprising a plurality of rear panels formed thereon, each of said rear panels having an exposed exterior surface and an interior surface, and said rear face extending vertically and substantially parallel with said front face when the shade is lowered, and wherein respective interior facing surfaces of said rear and front panels form an insulating cell;
a plurality of horizontally extending and vertically spaced pleat assemblies, said pleat assemblies extending between adjacent pairs of said rear and front panels, each pleat assembly comprising (i) a first fold made in said front face (ii) a second fold made in said rear face, each said fold being oriented horizontally, (iii) at least one retaining strip securing said folds, and (iv) at least one eyelet secured to said folds and said at least one retaining strip, said eyelet having an opening formed therethrough; and
at least one drawstring extending through said opening of each eyelet.

2. A Roman shade, as claimed in claim 1, wherein:
said at least one retaining strip includes a first pair of retaining strips and a second pair of retaining strips, said first pair of retaining strips being secured to said first fold, and said second pair of retaining strips being secured to said second fold.

3. A shade, as claimed in claim 1, further comprising:
a header secured to most upper front and rear panels of said plurality of front and rear panels.

4. A shade, as claimed in claim 1, further comprising:
a bottom rail secured to a lower rear and front panel of said plurality of rear and front panels.

5. A shade, as claimed in claim 1, further comprising:
a sheer assembly secured to a lower end of said shade, said sheer assembly comprising an accordion folded panel, a lower rail, and at least one drawstring for raising and lowering said sheer assembly with respect to said shade.

6. A Roman shade comprising:
a flexible front face having a plurality of front panels formed thereon, each of said panels having an exposed exterior surface and an interior surface, and said front face extending vertically when the shade is lowered;
a flexible rear face comprising a plurality of rear panels formed thereon, each of said rear panels having an exposed exterior surface and an interior surface, and said rear face extending vertically and substantially parallel with said front face when the shade is lowered, and wherein respective interior facing surfaces of said rear and front panels form an insulating cell;
a plurality of horizontally extending and vertically spaced pleat assemblies, said pleat assemblies extending between adjacent pairs of said rear and front panels, each pleat assembly comprising folds made in said front and rear panels and at least one retaining strip securing said folds.

7. A shade, as claimed in claim 6, further comprising:
at least one eyelet secured to said folds and said at least one retaining strip, said eyelet having an opening formed therethrough.

8. A shade, as claimed in claim 6, further comprising:
at least one drawstring extending through said opening of each eyelet.

9. A shade, as claimed in claim 6, further comprising:
a header secured to most upper front and rear panels of said plurality of front and rear panels.

10. A shade, as claimed in claim 6, further comprising:
a bottom rail secured to a lower rear and front panel of said plurality of rear and front panels.

11. A shade, as claimed in claim 6, further comprising:
a sheer assembly secured to a lower end of said shade, said sheer assembly comprising an accordion folded panel, a lower rail, and at least one drawstring for raising and lowering said sheer assembly with respect to said shade.

12. A shade, as claimed in claim 6, wherein:
said insulating cells are rectangular shaped.

13. A Roman shade comprising:
a flexible front face having a plurality of front panels formed thereon, said front face extending vertically when the shade is lowered;
a flexible rear face comprising a plurality of rear panels formed thereon, said rear face extending vertically and substantially parallel with said front face when the shade is lowered;
a plurality of insulating cells formed from said front face and said rear face, said insulating cells having a rectangular shape;
a plurality of horizontally extending and vertically spaced pleat assemblies, said pleat assemblies extending between adjacent pairs of said rear and front panels, each pleat assembly comprising folds made in said front and rear panels and means for securing said folds to maintain them in a substantially horizontal orientation.
